(19) United States
(12) Patent Application Publication
(10) Pub. No.: US 2016/0348732 A1
(43) Pub. Date: Dec. 1, 2016

(54) ELASTIC JAW COUPLING

(71) Applicant: CENTA-ANTRIEBE KIRSCHEY GmbH, Haan (DE)

(72) Inventors: Jochen EXNER, Hennef (DE); Martin FITSCH, Wuppertal (DE)

(21) Appl. No.: 15/134,655

(22) Filed: Apr. 21, 2016

(30) Foreign Application Priority Data
May 27, 2015 (DE) 102015108324.8

(51) Int. Cl. F16D 3/68

(52) U.S. Cl. CPC F16D 3/68

(57) ABSTRACT

Illustrated and described is, among other things, an elastic claw coupling (10) for transmitting torques from a drive unit (11) to a driven unit (12) with a first coupling section (14) assigned to the drive, and a second coupling section (15) assigned to the drive that both rotate about a common rotational axis (13), wherein claws (18, 19) are arranged on both coupling sections that extend radially outward from the relevant coupling sections and axially to achieve axial overlapping with the respective other coupling section, wherein two claws arranged angularly adjacent about the rotational axis form between them an accommodation space (32a, 32b, 32c, 32d, 32e) for an elastic element. The special feature consists in the fact that in the circumferential direction a plurality of elastic elements (25a, 25b, 25c) of the first type and a plurality of elastic elements (26a, 26b, 26c) of a second type are provided, wherein the elastic elements of the second type differ from the elastic elements of the first type in terms of their geometry and/or in terms of their material properties.

The invention initially relates to an elastic claw coupling in accordance with the preamble of claim 1.

Such claw couplings are known and have been developed and manufactured by the applicant for decades. An example of an elastic claw coupling of this type is disclosed in DE 10 2013 004 583 [US 2014/0274422] by the applicant.

In this coupling the torque transmission from the first coupling section to the second coupling section exclusively takes place via elastic elements that in the prior art are designed as circular cylinders. In thus far they are in the shape of rollers. This type of coupling is therefore known as a roller coupling.

On the basis of the coupling in accordance with the introductory section of claim 1, the aim of the invention is to further develop the coupling in such a way that it exhibits better coupling properties.

The invention solves this task with the features of claim 1, in particular with those of the characterising section and is accordingly characterized in that in the circumferential direction a plurality of elastic elements of a first type and a plurality of elastic elements of a second type are envisaged, wherein the elastic elements of the second type differ from the elastic elements of the first type in terms of their geometry and/or in terms of their material quality.

The principle of the invention essentially consists in that in place of the completely identically designed elastic elements in the prior art, at least two groups of differently designed elements are provided. Accordingly, one group of elastic elements of a first type and one second group of elastic elements of a second type are to be provided.

The elastic elements of the first type can be completely identical to the circular cylindrically designed roller elements of the prior art.

More particularly, in accordance with the invention every second elastic element of the first type is replaced by a differently designed elastic element of the second type.

In comparison with the elastic element of the first type, the elastic element of the second type can exhibit a different geometry. For example, the elastic element of the second type can have a cross-section that differs from the cross-section of an elastic element of the first type. Whereas the elastic element of the first type can have a circular cylindrical cross-section, the elastic element of the second type can have a holding section and a clamping section. The holding section can, for example, serve as an attachment to an inner surface of a claw, and in thus far be firmly fastened relative to the adjacently arranged claw. For example, the holding section of the elastic element of the second type can have projections or bulges as plug-in or insertion sections that can positively interlock with correspondingly shaped pockets of the claw and thus firmly fix the elastic element of the second type relative to the correspondingly adjacent claw.

The elastic element of the second type can also have a clamping section that, for example, extends away from the holding section and, in particular, narrows. The clamping section can be arranged on a tensioning surface of an inner flank of a claw adjacent to the clamping surface. In this way the clamping section can cooperate with the tensioning surface so that in the assembled state of the coupling, without the application of load, the tensioning surface exerts a force directed in the circumferential direction on the clamping section.

In this way, depending on the selected geometric design and number of the elastic elements of the second type, the second coupling section can be tensioned with regard to the first coupling section. The elastic elements of the first type can in this way also be subject to a certain tensioning force.

This makes for an improved method of operation and the achievement of a coupling characteristic that, particularly in the case of a change of load, especially in the case of an abrupt change of load is positively noticed. In a coupling according to the prior art that exclusively uses identically designed elastic roller elements, during the course of load changes, loosening of surface of the elastic roller elements from the inner flanks of the claws can occur. This can lead on the one hand to a certain amount of noise developing and on the other hand to excessive and preferably avoidable wear.

In accordance with the invention, through the use of differently designed elastic elements, and in particular through a selection of different geometries of the elastic bodies, such surface loosening can be reduced or completely avoided in the event of load changes due to the achieved tensioning.

The elastic elements of the first type and the elastic elements of the second type—optionally of different cross-sections—have the same or essentially the same axial length.

According to a further aspect of the invention the elastic bodies of the first type and the elastic bodies of the second type can have a different material quality. In particular, both types of elastic elements can be made of an elastic, more particularly, rubber-elastic material, but have a different Shore hardness.

For example, it can be envisaged that the elastic elements of the first type, more particularly designed as circular cylindrical roller elements, have a Short hardness of 50 to 60 and the elastic elements of the second type, that for the same sake of simplicity are also known as buffer elements, have a Short hardness of around 80.

For the sake of good order it is noted that within the framework of the invention it can be envisaged that the elastic elements of the first type and/or the elastic elements of the second type can also have inlaid elements, for example also metallic inlaid elements that, for example are vulcanised into the rubber elastic mass of the elements.

For the sake of good order it is pointed out that invention also covers the elastic elements of the second type differing from the elastic elements of the first type in terms of both their geometric design, i.e. in particular their cross-section, and also their material quality.

Furthermore, it is advantageously envisaged that all the elastic elements of the first type are essentially identically configured or are essentially made of the same material and the elastic elements of the second type are also essentially identically configured and, in particular, are made of the same or essentially the same material.

Finally, the invention also covers the provision of more than two types of elastic element.

In accordance with an advantageous embodiment of the invention at least one claw can be mounted radially. Alternatively at least one element of a claw can be radially mounted. This allows radial assembly of the claw in relation to the first and/or the second coupling section. Advantageously, here, the coupling section is designed like a hollow circular cylinder or an annular element, or comprises such.

In accordance with one embodiment of the invention, on the claw, or in the case of a segmented claw, on a segment of the claw, a tensioning surface is arranged. In the assembled state the tensioning surface can exert a force angularly on the elastic element in contact with the tensioning surface. As a result of this force exertion the two coupling sections can also be tensioned with regard to each other.

At the same time the elastic elements of the first type are also tensioned.

The magnitude of the pre-tensioning force exerted angularly is determined, for example, by the number of elastic elements of the second type.

Preferably the tensioning surface on the claw or claw segment is aligned in such a way that with increasing radial approximation of the claw or the claw segment to the final assembly state or to the rotational axis, the exerted tensioning force increases. In the simplest case the tensioning surface is an oblique surface or control surface, aligned along one plane, and aligned at an acute angle to a central longitudinal plane of the coupling including the axis of rotation.

Preferably, during the continuing radial approximation of the claw or the claw element to the rotational axis the tensioning force is increased and the buffer element compressed.

It can, for example, be envisaged that during the course of assembly the claw or the claw segment bearing the tensioning profile is moved each time into the end position so that the tensioning force exerted by the tensioning surface is determined. It can also be envisaged, for example, that the tensioning force can later also be set by way of radial tracking subsequent to adjusting the distance of the tensioning surface from the rotational axis of the coupling. For example, readjustment or adjustment or adaptation of the tensioning force can take place during maintenance times.

In accordance with a further aspect of the invention the aim of the invention is solved by the features of claim 3. Accordingly it is envisaged that at least one claw or at least one segment of a claw can be radially assembled, wherein a tensioning surface is arranged on the claw or on the segment of the claw that is the assembled state exerts a force angularly on the elastic element in contact with the tensioning surface.

According to the invention a tensioning surface is provided that, during the course of radial fixing of the claw or during the course or radial fixing of the segment of the claw on the coupling section, can exert a tensioning force angularly. The tensioning surface is part of the accommodation space for an elastic element. Preferably it is envisaged that the coupling has elastic elements of the first type and elastic elements of the second type. It is also preferably envisaged that a plurality of tensioning surfaces is provided that only cooperate with the elastic elements of the second type.

In accordance with the invention the provision and arrangement of a tensioning surface allows the exertion of a tensioning force between the coupling sections so that the elastic elements are tensioned in the stress-free state of the coupling. Through this an improvement in the coupling properties can be achieved, particularly in the case of abrupt load changes. Through the exertion of such a tensioning force loosening of the surfaces of the elastic elements from the corresponding flanks of the clause can be reduced or avoided in the event of load changes.

According to an advantageous embodiment of the invention accommodation spaces of a first type and accommodation spaces of a second type are provided that are differently designed. Preferably all the accommodation spaces of the first type are identically configured and also preferably all the accommodation spaces of the second type are also identically configured. However, the accommodation spaces of the first type and the accommodation spaces of the second type differ from one another. In the circumferential direction of the coupling the accommodation spaces of the first type and the accommodation spaces of the second type can alternate or be arranged according to a predetermined regularity.

Preferably the geometry of the accommodation space of the first type is adapted to the geometry of the elastic element of the first type. In particular, the cross-section of the accommodation space of the first type is adapted to the geometry, more particularly the cross-section of the elastic element of the first type.

Also advantageously, the geometry, more particularly the cross-section, of the accommodation space of the second type is adapted to the cross-section of the elastic element of the second type.

With regard to this, it can, in particular, be envisaged that although the coupling uses exclusively identical claws that are arranged, for example, in a mirror-inverted manner on a radial plane between the two coupling sections, the claws can, however, be asymmetrically configured with regard to their central longitudinal plane in order to thereby provide differently formed accommodation spaces of the first and second type.

According to a further advantageous embodiment of the invention, a majority of the claws has at least two segments, more particularly two segment that can be assembled in the radial direction, wherein, in particular, at least one foot segment and at least one head segment is provided. The tensioning surface is also preferably arranged on the head segment.

This allows the provision of a coupling in which initially the foot segments of the claw are fixed to the relevant coupling section, e.g. to the first coupling section and to the second coupling section, and the elastic elements, more particularly the elastic elements of the first type and the elastic elements of the second type are then introduced into the relevant accommodation spaces.

Only in a final stage can the corresponding head segment be attached to the foot segment or directly to the first coupling section or to the second coupling section. During the course of fastening of the head segment, more particularly during its radial bringing in, continuously approaching the rotational axis, the tensioning section arranged on the head segment can act on the elastic elements, particularly on the elastic elements of the second type and build up a force directed angularly, so that after assembly of the head segment tensioning of the two coupling section relative to each other angularly is achieved.

According to an advantageous embodiment of the invention, the elastic elements of the second type differ from the elastic elements of the first type solely in terms of their cross-section. Covered by the invention in particular is the fact that the elastic elements of the first type have a circular cross-section and the elastic elements of the second type have a cross-section deviating therefrom. The elastic elements of the second type, can, in particular, have an essentially triangular cross-section. According to the invention it can be envisaged that the cross-sectional shape of the elastic element of the second type is formed by a holding section and a clamping section. The holding section can have areas or sections with which fixation of the elastic element of the second type to the corresponding claw takes place. More particularly, immovable fixation of the elastic element of the second type to the corresponding claw is possible in this way.

The clamping section abuts the opposite flank of the neighbouring claw. In particular, the clamping section abuts the tensioning surface. During the assembly of the head section of the claw and during continuous approximation of the tensioning surface to the rotational axis of the coupling, the clamping section, and thereby the elastic element of the second type is entirely compressed angularly. In this way a tensioning force is exerted angularly.

Also advantageously, it is envisaged that the elastic elements of the first type and the elastic elements of the second type are arranged about the rotational axis at the same or essentially the same radius.

This consideration relates to the approximate geometry center of gravity or midpoint of the elastic elements of the first type and the elastic elements of the second type. The elastic elements of the second type can be called buffer elements. These buffer elements can cushion overload jolts occurring during operation.

In particular, in accordance with the invention it is envisaged that the elastic elements of the first type and the elastic elements of the second type have different vibration damping characteristics.

Also covered by the invention is if in addition to the elastic elements of the second type providing certain pre-tensioning, further tensioning elements such as wedge elements or equivalent are provided.

A further advantageous aspect of the invention consists in that directly on the claw, more particularly on the head segment of the claw, a holder for the elastic element of the second type is provided. In the examples of embodiment shown in the FIGS. the holder is essentially in the form of insertion or holding slits or holder receptacles. However, other types of holder can also be considered.

Further advantages arise out of the uncited sub-claims, as well as the following description of the examples of embodiment.

In the figures:

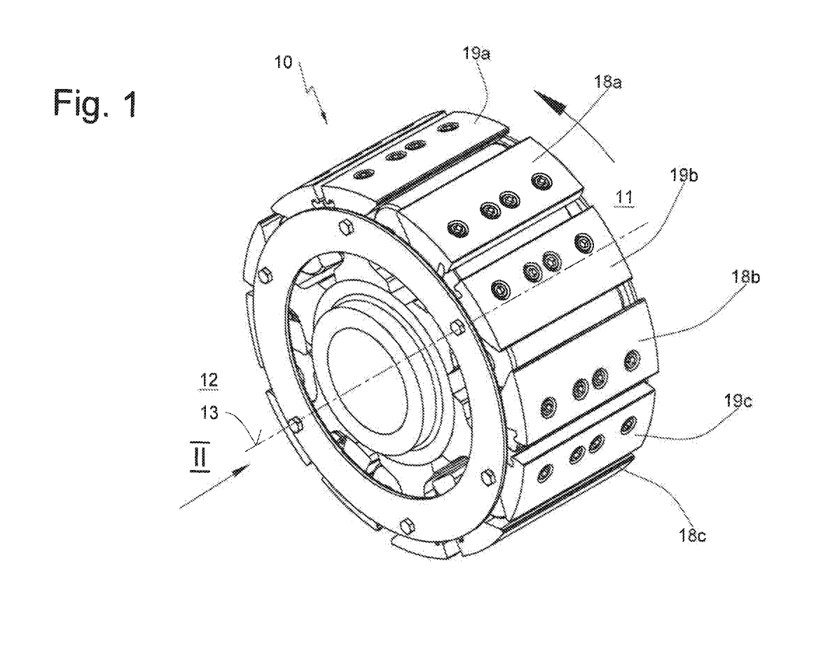

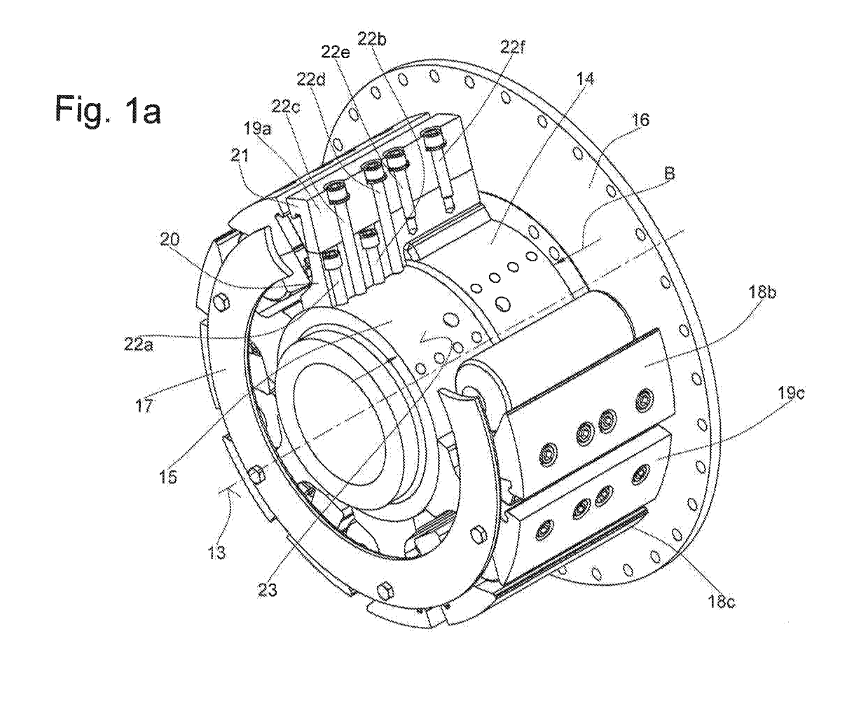

FIG. 1 shows a schematic, perspective view of a first form of embodiment of a coupling in accordance with the invention,

FIG. 1a shows a partial cross-sectional, schematic, perspective view of the example of embodiment in FIG. 1, wherein additionally on the drive unit side a flange is shown, and wherein for the purpose of illustration a circumferential segment of the coupling of around 75 angular degree is kept free of claws,

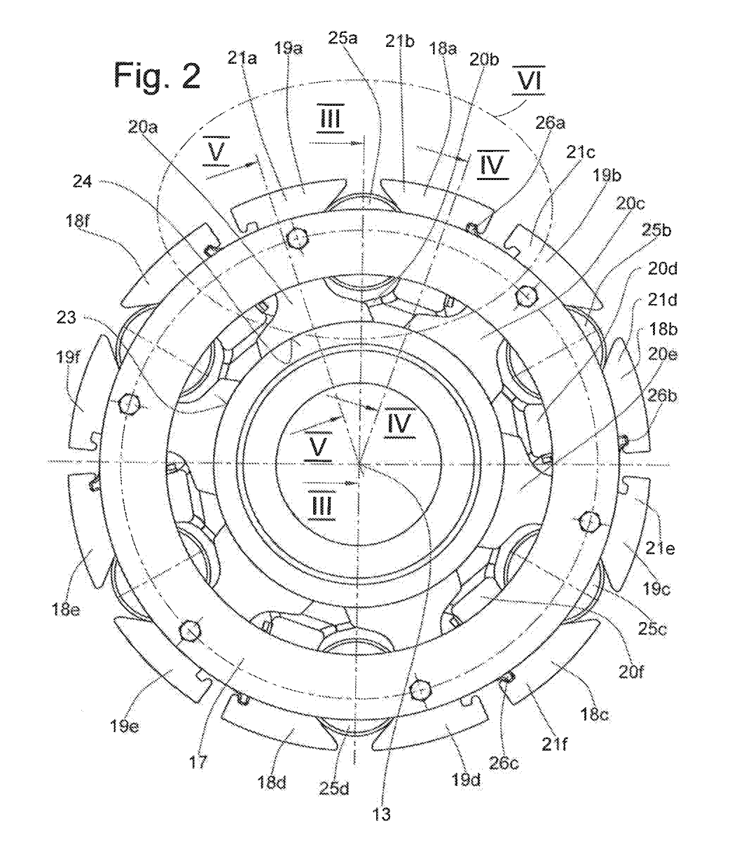

FIG. 2 shows a schematic view of the coupling of FIG. 1 according to arrow II in FIG. 1,

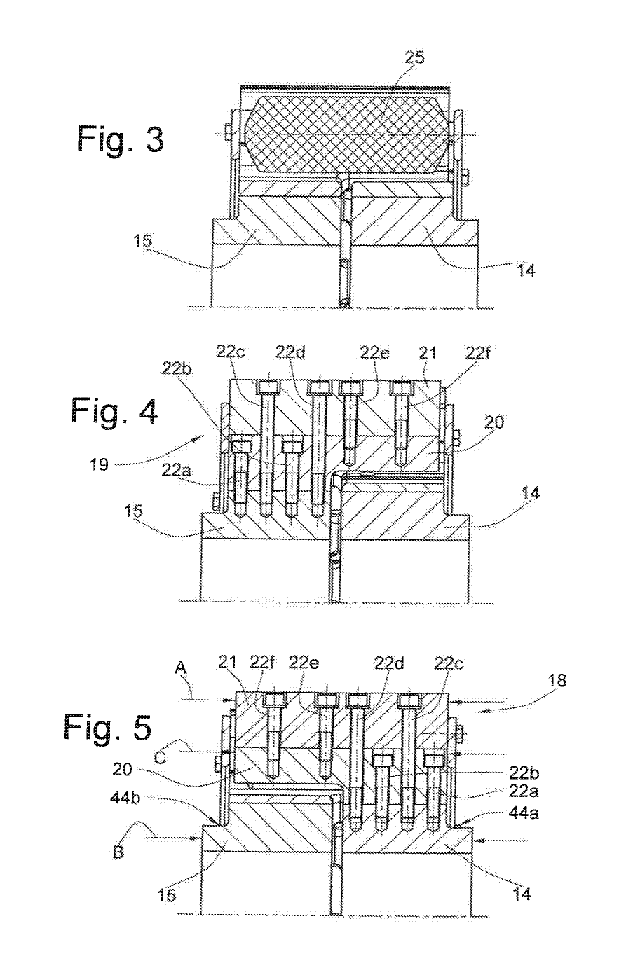

FIG. 3 shows a partial cross-sectional, schematic view of a partial cross-section through the coupling of FIG. 2 approximately along line in FIG. 2,

FIG. 4 shows a schematic, partial cross-sectional view through the coupling of FIG. 2, approximately along line IV-IV in FIG. 2,

FIG. 5 shows, in a view according to FIG. 4, a partial cross-sectional view of the device in FIG. 2, approximately along line V-V in FIG. 2,

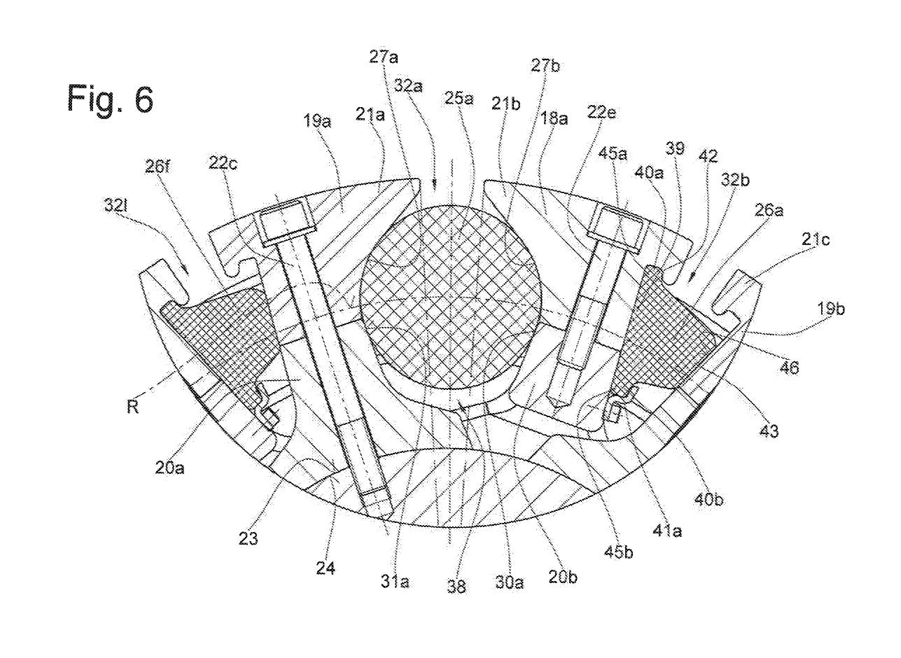

FIG. 6 shows an enlarged, partial cross-sectional, schematic view of an area of the coupling of FIG. 2, approximately along part circle VI in FIG. 2, wherein the schematic view in FIG. 6 corresponds to a sectional plane that in the direction of view of the observer of FIG. 2 lies behind the paper plane,

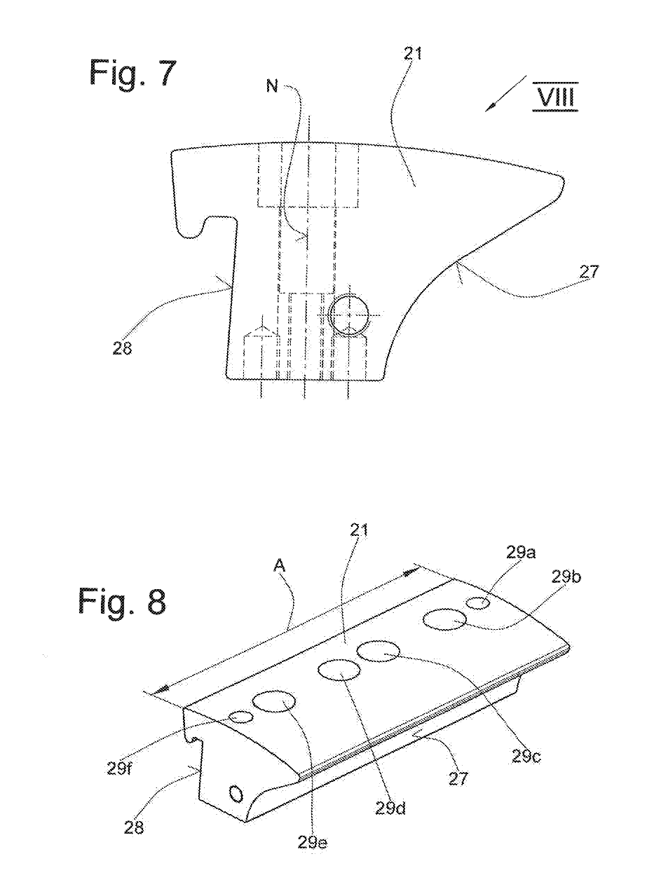

FIG. 7 shows a partial cross-sectional, schematic view of an end view of a head segment of a claw,

FIG. 8 shows a schematic, perspective view of the claw of FIG. 7, approximately in accordance with arrow VIII in FIG. 7,

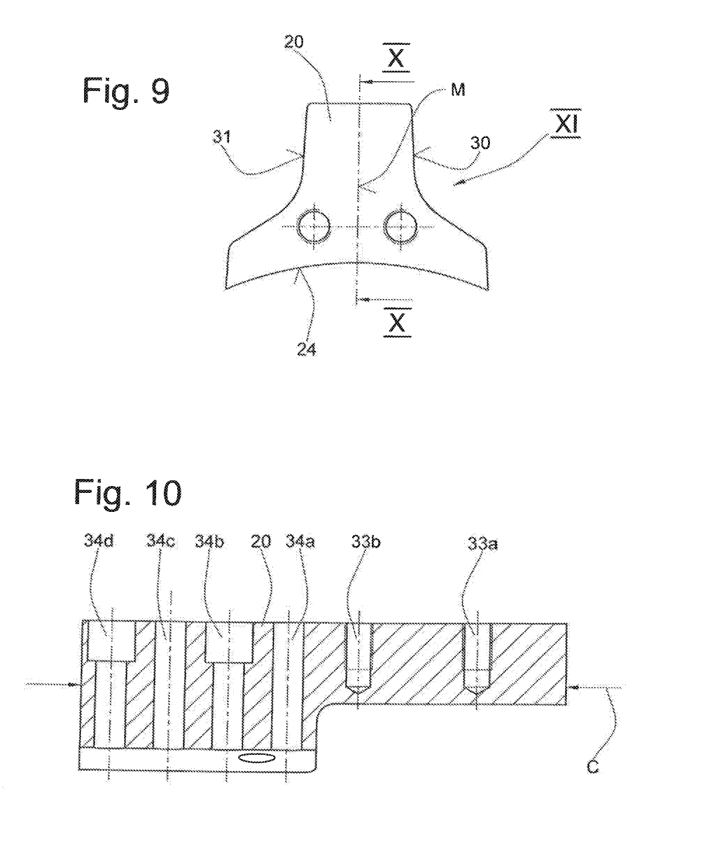

FIG. 9 shows an individual schematic end view of a foot segment of a claw,

FIG. 10 shows a cross-sectional view through the claw of FIG. 9, approximately along line X-X in FIG. 9,

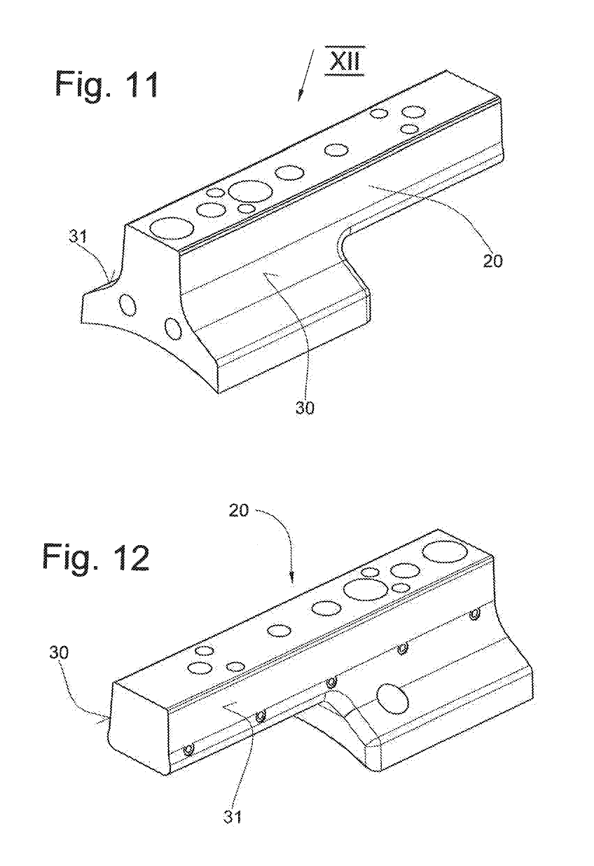

FIG. 11 shows a schematic, perspective view of the claw of FIG. 9, approximately in accordance with arrow XI in FIG. 9,

FIG. 12 shows a rear view of the claw of FIG. 11 approximately along arrow XII in FIG. 11,

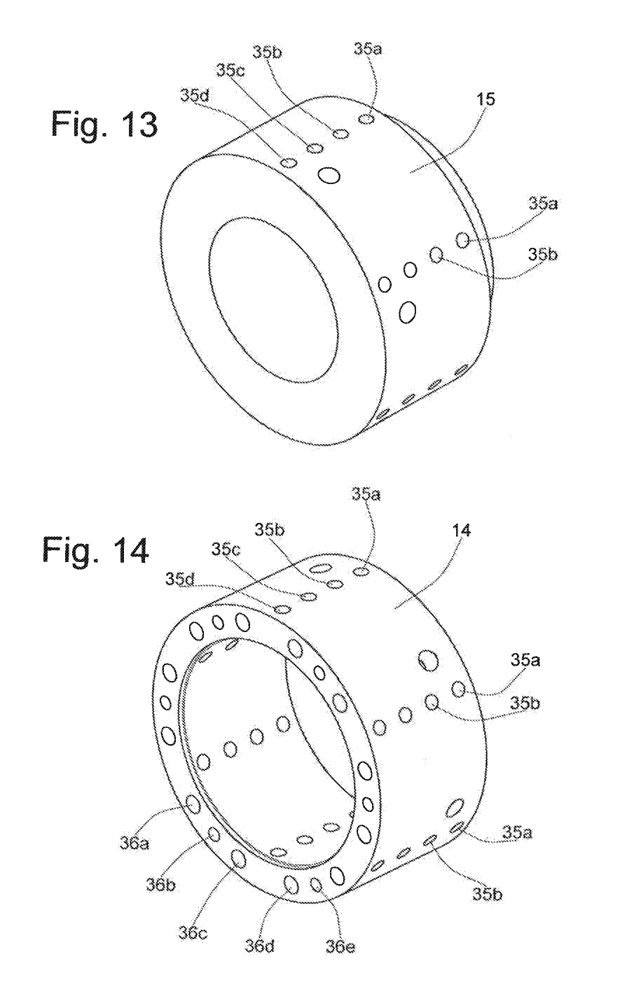

FIG. 13 shows an individual, perspective view of a second coupling element with radial screw holders,

FIG. 14 shows an example of embodiment of a first coupling section in a view according to FIG. 13 with axial screw holders in addition to the radial screw holders,

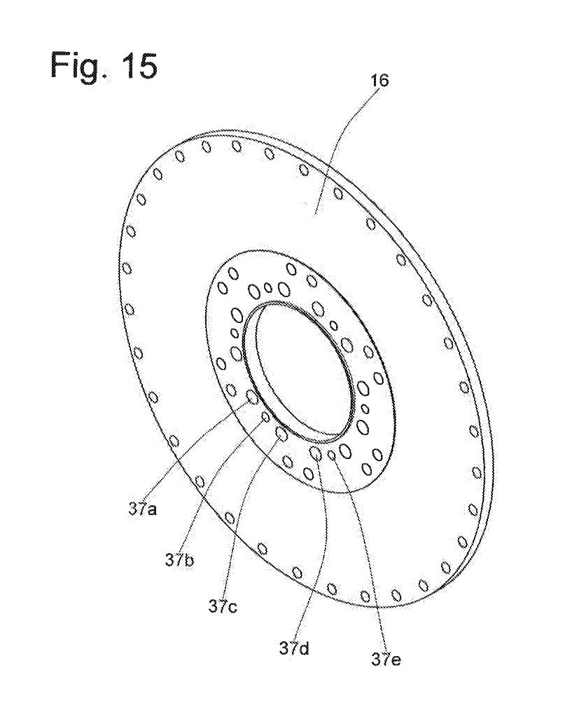

FIG. 15 shows a perspective view of a fastening flange for fastening to the drive unit, e.g. on the fly-wheel of a motor, as well as for axial fastening to the axial screw holders of the first coupling section shown in FIG. 14,

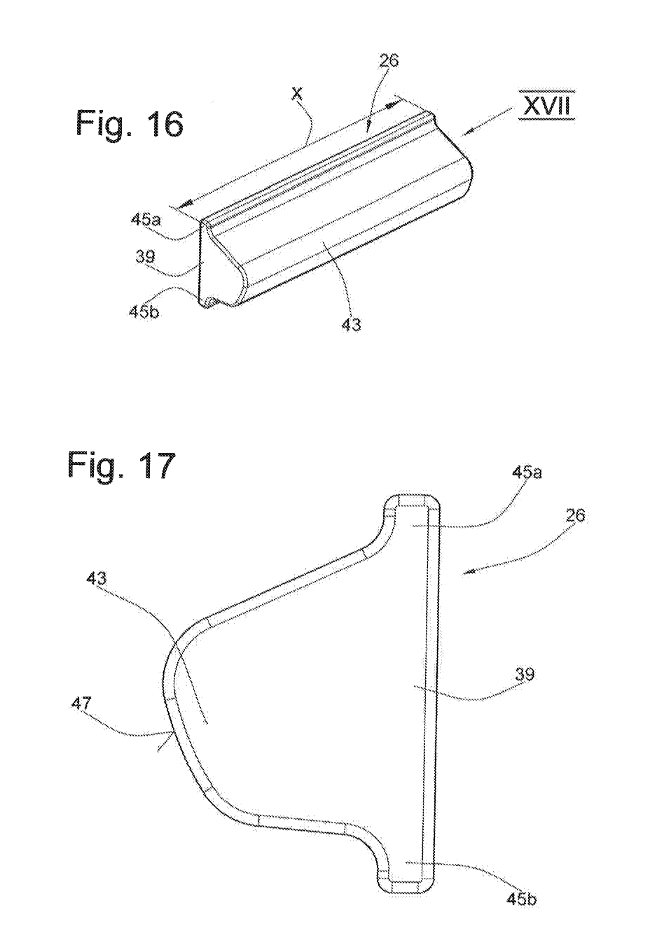

FIG. 16 shows a perspective view of an elastic element of the second type and

FIG. 17 shows an end view of the elastic element of the second type of FIG. 16, approximately along arrow XVII in FIG. 16.

Examples of embodiment of the invention are described in the following description of the figures, also with reference to the drawings. For the sake of clarity—and if different examples of embodiment are involved—the same or comparable parts or elements or areas are designated with the same reference numbers, in some cases with the addition of small letters.

Within the context of the invention, features that are only described with reference to one example of embodiment can also be provided in every other example of embodiment of the invention. Such altered examples of embodiment are—even if not shown in the drawings—also covered by the invention.

All the disclosed features are, per se, essential to the invention. Included in full in the disclosure of the application is also the disclosure content of the associated priority documents (copy of the prior application) as well as of the cited documents and described device of the prior art, also for the purpose of including individual or several feature of these documents in one or more claims of the present application.

The claw coupling designated in its entirety as 10 in the FIGS. will initially be explained by way of the examples of embodiment of FIGS. 1 and 1a.

According to FIG. 1 the elastic claw coupling 10 serves to transmit torques about a geometric axis designated 13 from a drive unit, which is not shown, located at approximately 11, to a driven unit, which is not shown, located at approximately 12.

The drive unit 11 can be an internal combustion engine or an electric motor for example.

The driven unit 12 can, for example, be formed by a gear mechanism that is connected to the coupling 10 via a drive shaft that is not shown.

The coupling 10 can be designed in the form of a shaft-shaft or a shaft-flange or also a flange-flange connection that will be discussed in more detail later.

As perhaps best made evident from the opened, perspective view in FIG. 1a, the coupling 10 comprises a first coupling section 14 and a second coupling section 15. Both coupling sections 14, 15 are in the form of circular cylindrical annular bodies. Preferably they have the same inner diameter and same outer diameter and the same axial length.

As can be seen in particular in FIGS. 13 and 14 on the outer lateral surface of the two coupling sections 14, 15 a plurality of radial screw holders 35a, 35b, 35c, 35d, 35e is provided that are only shown partially and as examples.

These screw holders make radial fastening of the claw 18, 19 possible.

Whereas the example of embodiment of FIG. 1 is an example of a coupling 10 of the shaft-shaft connection type, to an observer of FIG. 1a it is clear that the coupling 10 can also be configured as a shaft-flange connection. The flange is marked 16 in FIG. 1a and illustrated individually in FIG. 5.

In addition to the radial screw holders 35a, 35b, 35c, 35d, 35e the first coupling section 14 according to FIG. 14 additionally has axial screw holders 36a, 36b, 36c, 36d, 36e that are also only partially shown.

These correspond with axial bores 37a, 37b, 37c, 37d, 37e of the fastening flange 16 according to FIG. 15.

Irrespective of whether the coupling 10 is to be designed as a shaft-shaft connection or as a shaft-flange connection the claws 18, 19 can always be radially fastened to the coupling sections 14, 15.

Solely for the sake of completeness it is pointed out that the coupling sections 14, 15—which is not shown—can either transition in one piece into a shaft, or can be connected in the inside in a torque-proof manner to a shaft, for example by means of a screw fastening or by tight fitting, i.e. form fitting. In accordance with FIG. 1a it becomes clear that the claw marked 19a there—a claw of a second type—is firmly screwed via four screws 22a, 22b, 22c, 22d to the second coupling section 15. The claw 19a is thus connected to the second coupling section 15 in a torque-proof manner.

Claw 18a arranged adjacently to the right of claw 19a in the circumferential direction, in relation to FIG. 1 is—which is not made clear in FIG. 1—firmly screwed to the first coupling section 14 in an analogue manner and is therefore designated a claw of a first type.

In relation to the circumferential direction, in an alternating sequence a claw 19 is screwed to the second coupling section 15, and an adjacently arranged claw 18 is screwed to the first coupling section 14.

The claws connected in a torque-proof manner to the first coupling section 14 are designated as claws of a first 18 and the claws connected in a torque-proof manner to the second coupling section 15 are designated as claws of a second type 19.

The partial cross-sectional view in FIG. 1a shows that the claw designated 19a there consists of two parts, namely a foot segment 20 and a heat segment 21.

The head segment 21 is shown individually in FIGS. 7 and 8. On looking at the end view according to FIG. 7 it comes clear to a person skilled in the art that the head segment 21 has two entirely differently formed flanks 27 and 28. The axial length A (FIG. 8) of the head segment 21 essentially corresponds to the sum B (FIG. 5) of the axial lengths of the two coupling sections 14 and 15 in accordance with FIG. 1a, or is a little shorter.

The foot segment of a claw 18, 19 is shown individually in FIGS. 9 to 12. Here it can be seen that the axial length C corresponds to the axial length A of the head section 20.

Especially when looking at FIGS. 4 and 5 it can be seen that the axial length A of the head segment 21 and the axial length C of the foot segment 20 are shorter than the sum B of the axial lengths of the first coupling section 14 and the second coupling section 15.

On looking at FIGS. 4 and 5 it becomes clear that on the first coupling section 14 a first shoulder 44a and on the second coupling section 15 a second shoulder 44b is arranged, wherein the head segments 21 and the foot segments 20 end flush with the start of the shoulders 44a, 44b.

In other examples of embodiment of the invention it is not, however, necessary for corresponding shoulders 44a, 44b to be arranged on the first and the second coupling section 14, 15.

In accordance with a central longitudinal plane M the foot section 20 is essentially symmetrically configured so that the two side flanks 30, 31 are identical. In other examples of embodiment of the invention the two flanks 30, 31 are formed differently.

With regard to the central longitudinal plan N of the head segment 21 it is evident with reference to FIG. 7 that an asymmetrical embodiment has been chosen here.

According to FIG. 8 the head segment 21 has a plurality of screw holders 29a, 29b, 29c, 29d, 29e, 29f. In contrast to this, according to FIG. 10 the foot segment 20 has two screw thread holders 33a, 33b and four through screw openings or screw holders 34a, 34b, 34c, 34d.

In accordance with FIG. 1a, as well as FIGS. 4 and 5, in this example of embodiment fastening of the foot segment 20 to the corresponds first or second coupling section 14, 15 initially takes place by means of the screws 22a, 22b.

The relevant head segment 21 is then fastened directly to the appropriate coupling section 14, 15 by means of the screws 22c, 22d and at the same time, using screws 22e, 22f, it is connected directly to the corresponding foot segment 20.

In thus far, on looking at the illustration in FIG. 2 an equidistant arrangement of the claws 18a, 18b, 18c etc. of the first type and of the claws 19a, 19b, 19c etc. of the second type is brought about in the circumferential direction.

All the claws 19a, 19b, 19c are each designed identically and arranged with the same orientation or alignment.

Between two claws in each case, e.g. between claws 19a and 18a there is an accommodation space 32a, 32b, 32c for receiving and accommodating elastic elements, more particularly roller elements.

FIG. 2, but even better FIG. 6, clearly shows that elastic, essentially cylindrical roller elements 25 of a first type and, opposite thereto, differently configured elastic elements 26 of a second type are provided.

As can be seen for example from FIG. 3 and FIG. 6, in the unstressed state the elastic element 25 of the first type has an essentially circular cylindrical cross-section. The associated accommodation space 32a that is delimited by the corresponding flank sections, designated 27a, 27b, 30a, 31a in FIG. 6, has an essentially circular cylindrical cross-section.

However, in the example of embodiment of FIG. 6, as a part of the accommodation space 32a, a certain overflow space 38 can be seen that on radial deformation of the elastic element 25a under load allows the deformation and spreading of material into the overflow space 38.

In contrast to this the elastic element 26 of the second type has a different cross-section. It has a holding section 39 (FIG. 17) that with two projections 40a, 40b (FIG. 6) rests in fastening pockets on the claw. The fastening pocket 41a (FIG. 6) is provided by a separated element that can be fastened on the foot segment 20b.

The fastening pocket 40a is provided by a directly corresponding recess 42 on the head segment 21b.

In addition to the holding section 39, the elastic element 26 of the second type has an abutment section or clamping section 43 (FIG. 17) with which it abuts the adjacent claw, i.e. for example, in relation to FIG. 6 claw 19b and its associated flank 46.

In the case of radial fastening of the head segment of the claw 19b the elastic element 26a of the second type is pre-tensioned. This leads to tensioning of the two coupling sections 14, 15 angularly.

According to the present invention the claws of the first type 18 and the claws of the second type 19 can be identically configured for fastening to the different coupling sections 14, 15. They are therefore provided by the identical components so that storage and also the costs of manufacturing are simplified.

In addition, according to the invention it is envisaged that the two segments 20, 21 of which a claw 18, 19 consists, namely the foot segment 20 and the head segment 21, can each be made of different materials. For example, the head segment 21 can consist of aluminum or steel and the foot element 20 of steel. However, completely different methods of manufacturing can be selected. Thus, for instance, the foot segment could be a forged component and the head segment 21 could be, for example, a continuous casting profile cut to length.

Simple reworking to achieve as optimally matched flank surfaces 30, 31 as possible is also possible in accordance with the invention.

The invention also allows the provision of identical parts in the case of couplings with different hub diameters. Thus, according to one aspect of the invention, the mounting surface 24 of the foot segment 20 (FIG. 9) only has to be adapted to the outer lateral surface 23 of the first or the second coupling section 14, 15. In the case of different outer diameters of the first coupling section 14 or the second coupling section 15, which guides the different outer lateral surface bulges, through simple adaptation of the mounting surface 24, an otherwise identical foot segment 20 can be used. As adaption of the mounting surface 24 for changing the concavity, i.e. the bulge type or bulge size is possible, through simple reworking of an already existing foot segment 20, considerable processing time and costs can be saved compared with the prior art.

By way of FIGS. 16 and 17 the elastic elements of the second type, designated as 26 in FIGS. 16 and 17 will now be explained.

The elastic element 26 of the second type has an axial length X (FIG. 16) that essentially corresponds to the axial length A of the head segment 21. For the sake of completeness it is noted the axial length of the circular cylindrically-designed roller elements, the elastic elements 25 of the first type, also corresponds to the length X of the elastic element 26 of the second type.

According to FIG. 17 the elastic body 26 of the second type has an essentially truncated triangular cross-section. From of type of base, designated as holding section 39, a clamping section 43 extends that narrows in width. Arranged on the holding section 39 are two fastening sections 45a, 45b that are also known as projections 40. These projections are inserted into the corresponding fastening pockets 41a, 41b on the head segment 21 of the corresponding claw or on a corresponding holder on the foot segment 20.

In the assembled stated, as shown in FIG. 6 for example, the relevant flank 28 (FIG. 7) of the head segment 21c of FIG. 6 becomes a tensioning surface 46. With increasing radial approximation the head segment 21 to the rotational axis 13, i.e. during the mounting of the head segment 21 on the coupling 10, the tensioning surface 46 comes into contact with the end surface 47 (FIG. 17) of the elastic element 26 of the second type and compresses the elastic element 26 of the second type angularly.

Solely for the sake of completeness it is noted that the claw, designated 18a in FIG. 6, more particularly its head segment 21b, can initially be assembled, possibly with the elastic element 26a of the second type already inserted.

Only after fastening can the head segment of the adjacent claw 19b, designated 21c in FIG. 6, be radially mounted, and during the course of the continuous radial approximation to the rotational axis 13 bring about compression of the elastic element 26a angularly.

As a result of the compression of all the elastic elements 26a, 26b, 26c, 26d, 26e of the second type the first coupling section 14 and the second coupling section 15—in the unstressed state—are tensioned toward each other. This ensures that the elastic elements 25a, 25b, 25c, 25d, 25e of the first type are, at least slightly, tensioned.

In the event of sudden changes in load, as can occur during operation, particularly when using the coupling 10 in ore mills, stone mill, steel mills or equivalent, i.e. in applications in which abrupt jolts frequently occur, loosening of the surfaces of the claws e.g. the flanks 27a, 27b in accordance with FIG. 6, from the elastic element 25a, designated 25a in FIG. 6, can be avoided.

Two accommodation sections 32a, 32b of the coupling 10 adjoining each other angularly are configured differently. As can be seen in FIG. 6 in particular, accommodation spaces 32a, 32c, 32e etc. of a first type are provided that have an essentially circular cross-section and thus adapt to the circular cylindrical cross-section of the elastic elements 25 of the first type.

The accommodation spaces of the second type 32b, 32d, 32f are essentially triangular in design and are thus approximated to the cross-sectional contour of the elastic elements 26 of the second type.

As can be seen in FIG. 6 in particular, the midpoints of the elastic elements 25 of the first type and those of the elastic elements 26 of the second type essentially lie on the same radius R about the rotational axis 13.

According to an advantageous embodiment of the invention the foot segment 20 is in the form of a forged element, wherein the mounting surface 24 and possible also one or more flanks 30, 31 can be produced through a special forging method. In this way a foot segment 20 of the claw 18, 19 can be provided without reworking being required.

The head segment 21 is made of a different material, preferably aluminum, and can, for example, be provided in the form of a continuous casting profile.

1. An elastic claw coupling for transmitting torques from a drive unit to a driven unit with a first coupling section assigned to the drive unit, and a second coupling section assigned to the driven unit that both rotate about a common rotational axis, wherein claws are arranged on both coupling sections that extend radially outward from the relevant coupling section and axially to achieve axial overlapping with the other coupling section, wherein two claws arranged angularly adjacent about the rotational axis form between them an accommodation space for an elastic element, wherein in the circumferential direction a plurality of elastic elements of a first type and a plurality of elastic elements of a second type are provided, wherein the elastic elements of the second type differ from the elastic elements of the first type in terms of their geometry and/or in terms of their material properties.

2. The elastic claw coupling according to claim 1, wherein at least one claw or at least one segment of a claw is configured to be radially assembled, wherein on the claw or on the segment of the claw a tensioning surface is arranged that in the assembled state exerts a force angularly on the elastic element in contact with the tensioning surface.

3. An elastic claw coupling for transmitting torques from a drive unit to a driven unit with a first coupling section assigned to the drive unit, and a second coupling section assigned to the driven unit that both rotate about a common rotational axis, wherein claws are arranged on both coupling sections that extend radially outward from the relevant coupling section and axially to achieve axial overlapping with the respective other coupling section wherein two claws arranged angularly adjacent about the rotational axis form between them an accommodation space for an elastic element, wherein at least one claw or at least one segment of a claw is configured to be radially assembled, wherein on the claw or on the segment of the claw a tensioning surface is arranged that in the assembled state exerts a force angularly on the elastic element in contact with the tensioning surface.

4. The elastic claw coupling according to claim 3, wherein the circumferential direction a plurality of elastic elements of a first type and a plurality of elastic elements of a second type are provided, wherein the elastic elements of the second type differ from the elastic elements of the first type in terms of their geometry and/or in terms of their material properties.

5. The elastic claw coupling according to claim 1, wherein accommodation spaces of a first type and accommodation spaces of a second type are formed, wherein, in particular, the geometry of the accommodation space of the first type is adapted to the geometry of the elastic element of the first type and the accommodation space of the second space is adapted to the geometry of the elastic body of the second type.

6. The elastic claw coupling according to claim 1, wherein in the circumferential direction there is an alternating arrangement of elastic elements of the first type and elastic elements of the second type.

7. The elastic claw coupling according to claim 1, wherein at least a majority of the claws comprise at least two segments, more particularly in the radial direction and also at least one foot segment and a head segment, wherein the tensioning surface is arranged on one segment, more particularly the head segment.

8. The elastic claw coupling according to claim 1, wherein the elastic elements of the second type differ from the elastic elements of the first type in terms of their cross-section.

9. The elastic claw coupling according to claim 1, wherein the elastic elements of the second type have a clamping section that cooperates with the tensioning surface.

10. The elastic claw coupling according to claim 1, wherein the elastic elements of the second type have a holding section.

11. The elastic claw coupling according to claim 9, wherein the clamping section extends away from the holding section and narrows.

12. The elastic claw coupling according to claim 1, wherein the elastic elements of the first type are designed in the form of roller elements, more particularly essentially circularly cylindrically.

13. The elastic claw coupling according to claim 1, wherein the elastic elements of the second type a have a different Shore hardness from the elastic elements of the first type.

14. The elastic claw coupling according to claim 1, wherein the claws of both coupling sections are identically designed.

15. The elastic claw coupling according to claim 1, wherein the elastic elements of the first type and the elastic elements of the second type are arranged at the same radius about the rotational axis.
